(19) United States
(12) Patent Application Publication
(10) Pub. No.: US 2023/0126373 A1
(43) Pub. Date: Apr. 27, 2023

(54) SYSTEM AND METHOD FOR IMPROVING HARDWARE USAGE IN CONTROL SERVER USING ARTIFICIAL INTELLIGENCE IMAGE PROCESSING

(71) Applicant: Dong-eui University Industry-Academic Cooperation Foundation, Busan (KR)

(72) Inventors: Jongwook JANG, Busan (KR); Donggyu CHOI, Busan (KR); Minyoung KIM, Busan (KR)

(73) Assignee: Dong-eui University Industry-Academic Cooperation Foundation, Busan (KR)

(21) Appl. No.: 17/525,294

(22) Filed: Nov. 12, 2021

(30) Foreign Application Priority Data
Oct. 21, 2021 (KR) 10-2021-0141164

(51) Int. Cl. G06K 9/00; G06K 9/54; G06K 9/62; G06T 3/40; G06T 7/70

(52) U.S. Cl. CPC G06K 9/00986; G06K 9/54; G06K 9/6262; G06T 3/40; G06K 9/6288; G06T 7/70; G06T 2207/20081

(57) ABSTRACT

A system for improving hardware usage in a control server using artificial intelligence image processing, including: an image input unit receiving multiple images, temporarily storing input original images, and transmitting image data into one hardware component; an image data pre-processing unit converting multiple images into images with smaller resolution to process the multiple images according to the image resolution of a single image and concatenating the converted images into a single image; an artificial intelligence task performance unit retrieving a data learning model for an object to be recognized and performing an object recognition artificial intelligence task using the data for which pre-processing of image data has been applied; and a resultant image output unit checking boundary coordinates along which images are concatenated according to the number of input images and calculating the center coordinates of each recognized object in the vicinity of the image boundaries.

### CROSS-REFERENCE TO PRIOR APPLICATION

This application claims priority to Korean Patent Application No. 10-2021-0141164 (filed on Oct. 21, 2021), which is hereby incorporated by reference in its entirety.

### ACKNOWLEDGEMENT

This research was supported by a Ministry of Science and ICT (MSIT), Republic of Korea, under a Grand Information Technology Research Center support program (IITP-2021-2020-0-01791) supervised by an Institute for Information & communications Technology Planning & Evaluation (IITP).

### BACKGROUND

The present disclosure relates to image processing and, more particularly, to a system and a method for improving hardware usage in a control server using artificial intelligence image processing that enables efficient processing of a plurality of artificial intelligence processes that are inefficient or may not be performed in the control server using artificial intelligence image processing.

Among artificial intelligence technologies, deep learning is currently one of the fastest-changing and developing fields. New learning models and improved results are continually pouring in, and some applications have produced more accurate results than humans in the past decade.

However, these developments and interests often lead to the use of excessive technology to solve minor problems.

In the case of an artificial intelligence control system, the primary concern is to autonomously perform tasks conventionally done by humans or to reduce unnecessary actions. Until now, control technology has many areas to be solved by humans, and considering the current hardware performance, it readily leads to serious cost problems.

Currently, the cost may be reduced using a moderate model to achieve suitable performance. However, models and algorithms to obtain better results afterward require more powerful hardware due to their complexity.

Although hardware technology has also been improved a lot, a system performed lightly as a whole is regarded as the optimal system.

On the other hand, as the use of image data is increasing worldwide, various technologies related to the use of image data are being developed. Since previously unsolved areas are now solved by new technologies of the 4th industrial revolution related to image data, additional functions are introduced to existing equipment.

The most basic thing in using image data is a camera.

Examples include the camera installed in a mobile phone up to the closed-circuit cameras installed nationwide and worldwide.

According to the data provided by the Korea public data portal as of July 2021, Busan area alone has 17539 closed-circuit cameras used for various purposes such as traffic enforcement, crime prevention, trash control, and child protection.

Comparitech, a British company focusing on computer and network security research, examined the number of CCTV cameras used in 150 major cities worldwide. According to the result, 16 of the top 20 cities were in China. The result showed that the camera density is 117.02 CCTVs per 1,000 people in the city with the largest population. Methods for managing the installation and utilization of numerous CCTVs through integrated control have long been studied.

In addition, many attempts are being made to introduce related technologies through the 4th industrial revolution. Considerable research has been conducted on data integrity verification using blockchain and object detection and intuitive situation understanding using artificial intelligence before data utilization.

Those cities trying to introduce intelligent CCTVs that analyze human behavior through AI are achieving significant progress. The size of the global intelligent CCTV market was USD 1093.4 billion in 2018 and is expected to grow at the CAGR of 7.8% to reach USD 1443.5 billion in 2022.

Meanwhile, to introduce artificial intelligence to CCTV, the following should be considered.

The biggest problem in introducing AI-based judgment to CCTVs in real life is that there are a huge number of cameras already installed, and it is too expensive to change them all. Even already installed ones are high-performance cameras and are expensive to purchase.

Since high-performance cameras are already in use, adding required functions and replacing only a part of the server is more realistic.

Systems employing artificial intelligence are already installed in the CCTVs on the street and in public places and transportation seats to respond to incidents and accidents. Various methods for immediately detecting traffic accidents and information on mistakes from real-time video and automatic control thereof are being sought to be used on the roads.

Among them, research to reduce the use of hardware in case of abnormality of CCTV itself is being conducted.

For example, research is being conducted on using a partial segment rather than checking all the data in the captured video to detect abnormal and unusual behavior. The study considers providing detection of abnormal behavior in the video as a default function and, at the same time, avoiding overloaded use of data to respond to an abnormal operation of the device itself.

However, the research overlooks the fact that CCTVs provide multiple inputs, which is a characteristic of CCTV.

In fact, a plurality of CCTV cameras rather than one are used, and their data are processed so that multiple videos are viewed all together. Research to introduce artificial intelligence is active, but a method suitable for the actual environment is needed before introducing artificial intelligence.

Moreover, the biggest problem of the intelligent system, that the system is too heavy and it is difficult to maintain the system at low costs, has not yet been solved.

An inference system typically occupies one processor for handling one input data and uses one processing unit, which makes it inefficient.

As described above, image processing using deep learning is performed by retrieving one trained model and loading the model onto the hardware to be used. A problem occurs since large resources are required for the model, and the processor is occupied for data processing.

Therefore, there is demand for developing a new technology to reduce the amount of hardware used in the image recognition process using artificial intelligence.

### PRIOR ART REFERENCES

### Patents

(Patent 1) Korea registered patent 10-1154350

(Patent 2) Korea laid-open patent 10-2020-0134813

(Patent 3) Korea registered patent 10-1996167

### SUMMARY

The present disclosure is intended to solve the problem of the existing image data processing technology, and an object of the present disclosure is to provide a system and a method for improving hardware usage in a control server using artificial intelligence image processing that enables efficient processing of a plurality of artificial intelligence processes that are inefficient or may not be performed in the control server using artificial intelligence image processing.

An object of the present disclosure is to provide a system and a method for improving hardware usage in a control server using artificial intelligence image processing that processes a plurality of image data by compressing and concatenating a plurality of input data in consideration of the data input size to handle multiple data simultaneously and resolves the difficulty in an image processing task performed in real-time.

An object of the present disclosure is to provide a system and a method for improving hardware usage in a control server using artificial intelligence image processing that reduces a system construction cost by reducing the use of artificial intelligence and the amount of hardware usage by applying an algorithm evaluating the data recognized at the boundaries of multiple input data.

An object of the present disclosure is to provide a system and a method for improving hardware usage in a control server using artificial intelligence image processing that efficiently performs artificial intelligence image processing within a given environment without involving software and hardware updates to use the artificial intelligence technology continually.

An object of the present disclosure is to provide a system and a method for improving hardware usage in a control server using artificial intelligence image processing that processes multiple data using one hardware component by designing an optimal task processed according to the size of input image data by including a process which receives images, compresses image resolution appropriately to be suitable for the number of input cameras, performs deep learning, and crops out the input images subsequently before executing an artificial intelligence model.

Technical objects to be achieved by the present disclosure are not limited to those described above, and other technical objects not mentioned above may be clearly understood from the descriptions given below by those skilled in the art to which the present disclosure belongs.

To achieve the technical objects above, a system for improving hardware usage in a control server using artificial intelligence image processing according to the present disclosure comprises an image input unit receiving multiple images, temporarily storing input original images, and transmitting image data into one hardware component; an image data pre-processing unit converting multiple images into images with smaller resolution to process the multiple images according to the image resolution of a single image and concatenating the converted images into a single image; an artificial intelligence task performance unit retrieving a data learning model for an object to be recognized and performing an object recognition artificial intelligence task using the data for which pre-processing of image data has been applied; and a resultant image output unit checking boundary coordinates along which images are concatenated according to the number of input images and calculating the center coordinates of each recognized object in the vicinity of the image boundaries, checking the distances from the center point of each object to the image boundaries and the length ratio of horizontal ends of the object and performing calculation of coordinate generation in proportion to the original image size through the detected coordinates of the object, and converting an object detection area in proportion to the original image size and outputting a resultant image by displaying the corresponding coordinates and detected area on each original image.

Here, the image data pre-processing unit includes an image size conversion unit converting multiple images into images with a smaller size to be processed according to the resolution of a single image and a single image generation unit concatenating the converted images at the same size into a single image.

And the resultant image output unit includes a boundary coordinate checking unit checking boundary coordinates along which images are concatenated according to the number of input images, a center coordinate detection calculation unit calculating detection of center coordinates of each recognized object in the vicinity of the image boundaries, a length ratio checking unit checking the distances from the center point of each object to the image boundaries and the length ratio of horizontal ends of the object, and a boundary coordinate distance comparison unit comparing a distance from the center point of an object to the image boundary with a half horizontal length of the object.

And the boundary coordinate distance comparison unit compares the distance from an object's center position to the image boundary with a half horizontal length of the object and excludes the corresponding object if the distance between the center point and the boundary coordinates is smaller than a reference value.

And the boundary coordinate distance comparison unit compares the distance from an object's center position to the image boundary with a half horizontal length of the object and limits a detected size of the corresponding object up to the image boundary if the distance between the center point and the boundary coordinates is larger than a reference value.

And the resultant image output unit further includes a coordinate generation calculation unit retrieving a temporarily stored original image by reflecting a comparison result of the boundary coordinate distance comparison unit and calculating generation of coordinates in proportion to the original image size through the object's detected coordinates, an object detection area conversion unit converting an object detection area in proportion to the original image size, and a detection area output unit outputting a resultant image by displaying the corresponding coordinates and detected area on each original image.

To achieve other technical objects, a method for improving hardware usage in a control server using artificial intelligence image processing according to the present disclosure comprises inputting images by receiving multiple images, temporarily storing input original images, and transmitting image data into one hardware component; pre-processing image data by converting multiple images into images with smaller resolution to process the multiple images according to the image resolution of a single image and concatenating the converted images into a single image; performing an artificial intelligence task by retrieving a data learning model for an object to be recognized and performing an object recognition artificial intelligence task using the data for which pre-processing of image data has been applied; and outputting a resultant image by checking boundary coordinates along which images are concatenated according to the number of input images and calculating the center coordinates of each recognized object in the vicinity of the image boundaries, checking the distances from the center point of each object to the image boundaries and the length ratio of horizontal ends of the object and performing calculation of coordinate generation in proportion to the original image size through the detected coordinates of the object, and converting an object detection area in proportion to the original image size and outputting a resultant image by displaying the corresponding coordinates and detected area on each original image.

Here, the pre-processing image data includes converting an image size converting multiple images into images with a smaller size to be processed according to the resolution of a single image and generating a single image concatenating the converted images at the same size into a single image.

And the outputting the resultant image includes checking boundary coordinates checking boundary coordinates along which images are concatenated according to the number of input images, calculating detection of center coordinates calculating detection of center coordinates of each recognized object in the vicinity of the image boundaries, checking a length ratio checking the distances from the center point of each object to the image boundaries and the length ratio of horizontal ends of the object, and comparing a boundary coordinate distance comparing a distance from the center point of an object to the image boundary with a half horizontal length of the object.

And the comparing the boundary coordinate distance compares the distance from an object's center position to the image boundary with a half horizontal length of the object and excludes the corresponding object if the distance between the center point and the boundary coordinates is smaller than a reference value.

And the comparing the boundary coordinate distance compares the distance from an object's center position to the image boundary with a half horizontal length of the object and limits a detected size of the corresponding object up to the image boundary if the distance between the center point and the boundary coordinates is larger than a reference value.

And the outputting the resultant image further includes calculating generation of coordinates by retrieving a temporarily stored original image by reflecting a comparison result of the boundary coordinate distance comparison unit and calculating generation of coordinates in proportion to the original image size through the object's detected coordinates, converting an object detection area converting an object detection area in proportion to the original image size, and outputting a detection area outputting a resultant image by displaying the corresponding coordinates and detected area on each original image.

And the outputting the resultant image uses the following pseudo equation for checking whether the position of an object detected in an image obtained by concatenating N images corresponds to a valid object actually existing in adjacent images, where the equation corresponding to 1 indicates that the corresponding detected image object belongs to the N-th image, and the equation corresponding to 0 indicates that the corresponding detected image object does not belong to the area.

$$Object in a image N = \{ \begin{matrix}1 & ( O . C . W - Image N start width > 1 / 4 O . C . W ) \&\& ( O . C . H - Image N start height > 1 / 4 O . C . H ) \\ 0 & New objects Recognized at Boundaries\end{matrix}$$

In the equation corresponding to 1, O.C.W represents the horizontal coordinate of a detected object's center when the top-left coordinates of the object are set to 0, and Image N start width represents the horizontal distance from the boundary of an adjacent image to the center of the detected object. On the other hand, O.C.H represents the vertical coordinate of a detected object's center when the top-left coordinates of the object are set to 0, and Image N start height represents the vertical distance from the boundary of the adjacent image to the center of the detected object.

And in the case of Image N start height, images concatenated in the horizontal direction unconditionally show the value of 1, and images concatenated in the vertical direction are used to check which part of an upper and a lower image contains an object. On the other hand, in the case of Image N start width, images concatenated in the vertical direction unconditionally show the value of 1, images concatenated in the horizontal direction are used to check which part of a left and a right image contains the object, and any object not belonging to the case of the pseudo equation corresponding to 1 is classified as false.

A system and a method for improving hardware usage in a control server using artificial intelligence image processing according to the present disclosure provide the following effects.

First, the system and the method according to the present disclosure enable a control server using artificial intelligence image processing to efficiently process a plurality of artificial intelligence processes that are inefficient or may not be performed.

Second, the system and the method according to the present disclosure process a plurality of image data by compressing and concatenating a plurality of input data in consideration of the data input size to handle multiple data simultaneously and resolve a difficulty in an image processing task performed in real-time.

Third, the present disclosure reduces a system construction cost by reducing the use of artificial intelligence and the amount of hardware usage by applying an algorithm evaluating the data recognized at the boundaries of multiple input data.

Fourth, the present disclosure enables artificial intelligence image processing to be performed efficiently within a given environment without involving software and hardware updates to use the artificial intelligence technology continually.

Fifth, the present disclosure provides a system and a method for improving hardware usage in a control server using artificial intelligence image processing that processes multiple data using one hardware component by designing an optimal task processed according to the size of input image data by including a process which receives images, compresses image resolution appropriately to be suitable for the number of input cameras, performs deep learning, and crops out the input images subsequently before executing an artificial intelligence model.

### BRIEF DESCRIPTION OF THE DRAWINGS

FIG. 1 shows the structure of a system for improving hardware usage in a control server using artificial intelligence image processing according to the present disclosure.

FIG. 2 shows a detailed structure of an image data pre-processing unit according to the present disclosure.

FIG. 3 shows a detailed structure of a resultant image output unit according to the present disclosure.

FIGS. 4A and 4B are flow charts illustrating a method for improving hardware usage in a control server using artificial intelligence image processing according to the present disclosure.

FIGS. 5A to 5D illustrate an example in which a method for improving hardware usage in a control server using artificial intelligence image processing according to the present disclosure is applied.

FIG. 6 illustrates a pseudo-equation in a question sentence for evaluating boundary images.

### DETAILED DESCRIPTION

In what follows, preferred embodiments of a system and a method for improving hardware usage in a control server using artificial intelligence image processing according to the present disclosure will be described in detail.

The characteristics and advantages of a system and a method for improving hardware usage in a control server using artificial intelligence image processing according to the present disclosure will be clearly understood through detailed descriptions on the respective embodiments below.

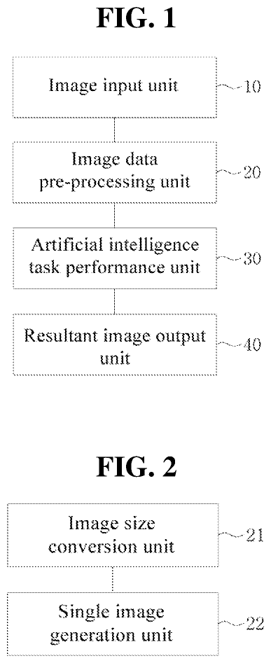

FIG. 1 shows the structure of a system for improving hardware usage in a control server using artificial intelligence image processing according to the present disclosure.

A system and a method for improving hardware usage in a control server using artificial intelligence image processing according to the present disclosure enable a control server using artificial intelligence image processing to efficiently process a plurality of artificial intelligence processes that are inefficient or may not be performed.

To this purpose, the present disclosure may include a structure that processes a plurality of image data by compressing and concatenating a plurality of input data in consideration of the data input size to handle multiple data simultaneously and resolves a difficulty in an image processing task performed in real-time.

The present disclosure may include a structure that processes multiple data using one hardware component by designing an optimal task processed according to the size of input image data by including a process which receives images, compresses image resolution appropriately to be suitable for the number of input cameras, performs deep learning, and crops out the input images subsequently before executing an artificial intelligence model.

A system and a method for improving hardware usage in a control server using artificial intelligence image processing according to the present disclosure do not alter a training model for deep learning.

Modifying a deep learning model may directly help improve the performance. However, it will take a long time to validate the modification and run a modified process, which will eventually affect hardware usage.

It is so because, although the model depth for deep learning may improve the accuracy, a deeper model depth is the opposite of making a lightweight system.

As shown in FIG. 1, a system for improving hardware usage in a control server using artificial intelligence image processing according to the present disclosure comprises an image input unit 10 receiving multiple images, temporarily storing input original images, and transmitting image data into one hardware component (server); an image data pre-processing unit 20 converting multiple images into images with smaller resolution to process the multiple images according to the image resolution of a single image and concatenating the converted images, namely, at the same size, into a single image; an artificial intelligence task performance unit 30 retrieving a data learning model for an object to be recognized and performing an object recognition artificial intelligence task using the data for which pre-processing of image data has been applied; and a resultant image output unit 40 checking boundary coordinates along which images are concatenated according to the number of input images and calculating the center coordinates of each recognized object in the vicinity of the image boundaries, checking the distances from the center point of each object to the image boundaries and the length ratio of horizontal ends of the object and performing calculation of coordinate generation in proportion to the original image size through the detected coordinates of the object, and converting an object detection area in proportion to the original image size and outputting a resultant image by displaying the corresponding coordinates and detected area on each original image.

A detailed structure of the image data pre-processing unit 20 according to the present disclosure is described below.

FIG. 2 shows a detailed structure of an image data pre-processing unit according to the present disclosure.

The image data pre-processing unit 20 includes an image size conversion unit 21 converting multiple images into images with a smaller size to be processed according to the resolution of a single image and a single image generation unit 22 concatenating the converted images at the same size into a single image.

A detailed structure of a resultant image output unit 40 according to the present disclosure is described below.

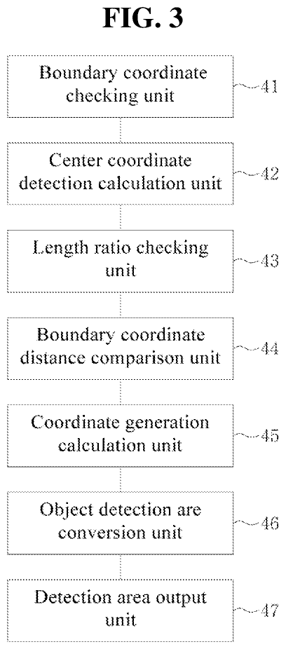

FIG. 3 shows a detailed structure of a resultant image output unit according to the present disclosure.

As shown in FIG. 3, a resultant image output unit 40 according to the present disclosure includes a boundary coordinate checking unit 41 checking boundary coordinates along which images are concatenated according to the number of input images, a center coordinate detection calculation unit 42 calculating detection of center coordinates of each recognized object in the vicinity of the image boundaries, a length ratio checking unit 43 checking the distances from the center point of each object to the image boundaries and the length ratio of horizontal ends of the object, and a boundary coordinate distance comparison unit 44 comparing a distance from the center point of an object to the image boundary with a half horizontal length of the object.

Here, the boundary coordinate distance comparison unit 44 compares the distance from an object's center position to the image boundary with a half horizontal length of the object and excludes the corresponding object if the distance between the center point and the boundary coordinates is smaller than a reference value.

And the boundary coordinate distance comparison unit 44 compares the distance from an object's center position to the image boundary with a half horizontal length of the object and limits a detected size of the corresponding object up to the image boundary if the distance between the center point and the boundary coordinates is larger than a reference value.

And the resultant image output unit 40 according to the present disclosure further includes a coordinate generation calculation unit 45 retrieving a temporarily stored original image by reflecting a comparison result of the boundary coordinate distance comparison unit 44 and calculating generation of coordinates in proportion to the original image size through the object's detected coordinates, an object detection area conversion unit 46 converting an object detection area in proportion to the original image size, and a detection area output unit 47 outputting a resultant image by displaying the corresponding coordinates and detected area on each original image.

A method for improving hardware usage in a control server using artificial intelligence image processing according to the present disclosure is described in detail as follows.

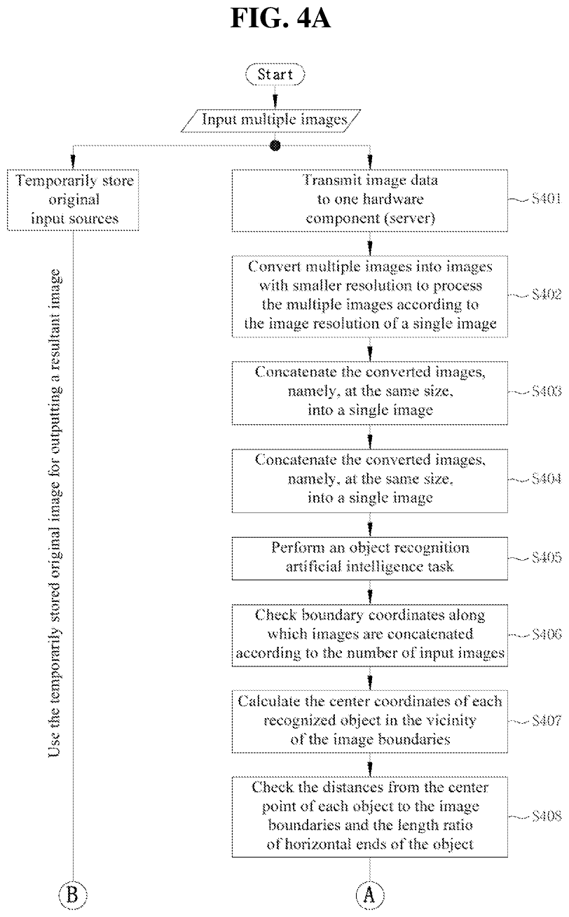

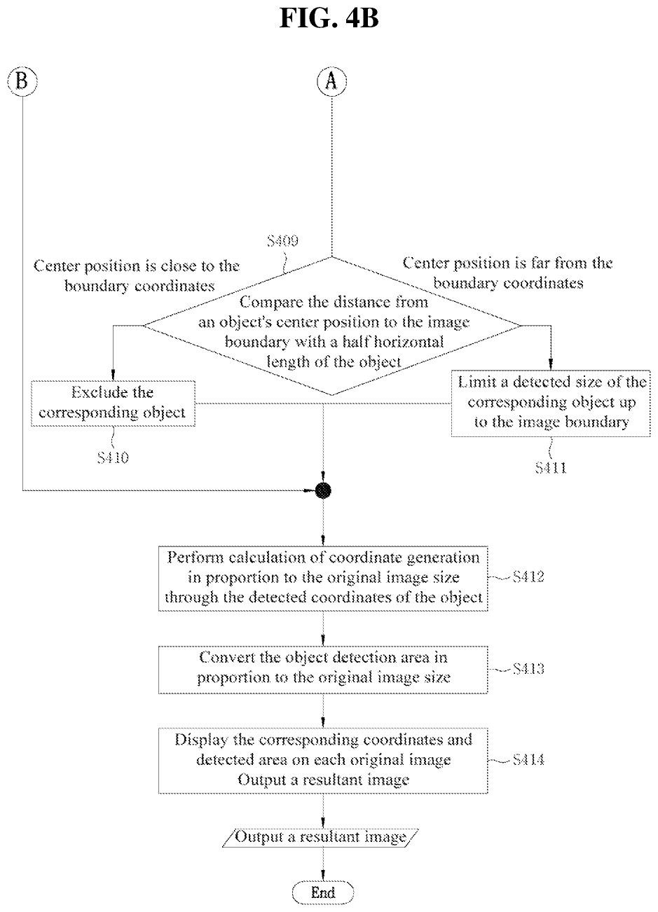

FIGS. 4A and 4B are flow charts illustrating a method for improving hardware usage in a control server using artificial intelligence image processing according to the present disclosure. First, the method for improving hardware usage in a control server using artificial intelligence image processing according to the present disclosure temporarily stores the original input sources when multiple images are received and transmits the image data to one hardware component (server) S401.

Next, the method converts multiple images into images with smaller resolution to process the multiple images according to the image resolution of a single image S402 and concatenates the converted images, namely, at the same size, into a single image S403.

And the method retrieves a data learning model for an object to be recognized S404 and performs an object recognition artificial intelligence task S405.

And the method performs the step of outputting a resultant image S406 to S414 as follows.

First, the method checks boundary coordinates along which images are concatenated according to the number of input images S406 and calculates the center coordinates of each recognized object in the vicinity of the image boundaries S407.

And the method checks the distances from the center point of each object to the image boundaries and the length ratio of horizontal ends of the object S408.

Next, the method compares the distance from an object's center position to the image boundary with a half horizontal length of the object S409 and excludes the corresponding object if the distance between the center point and the boundary coordinates is smaller than a reference value S410 while the method limits a detected size of the corresponding object up to the image boundary if the distance between the center point and the boundary coordinates is larger than the reference value S411.

And the method performs calculation of coordinate generation in proportion to the original image size through the detected coordinates of the object S412.

Next, the method converts the object detection area in proportion to the original image size S413 and outputs a resultant image by displaying the corresponding coordinates and detected area on each original image S414.

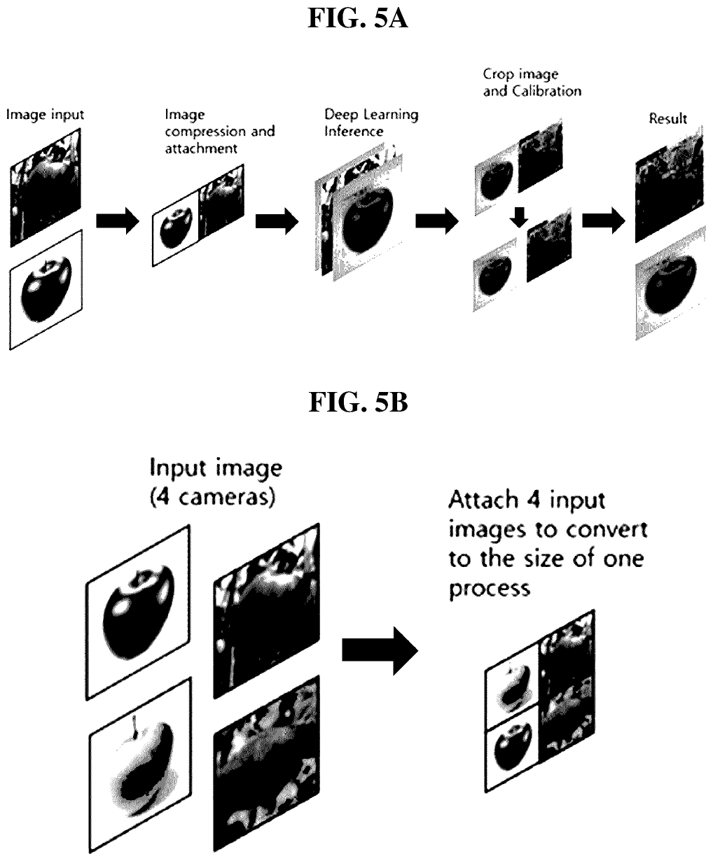

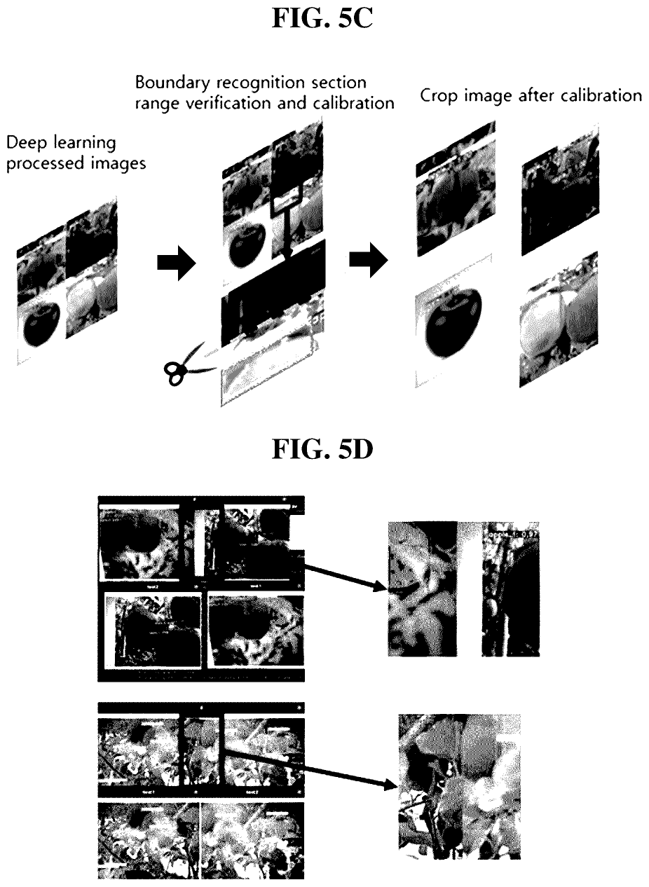

FIGS. 5A to 5D illustrate an example in which a method for improving hardware usage in a control server using artificial intelligence image processing according to the present disclosure is applied.

FIG. 5A shows an example of the overall process of a method for improving hardware usage in a control server using artificial intelligence image processing according to the present disclosure, where related processes are applied before and after performing a deep learning model.

Before performing the model, images are received, and their resolution is reduced appropriately according to the number of inputs cameras. After that, deep learning is performed, and the input images are cropped out subsequently.

FIG. 5B shows an example of an image data pre-processing process, which shows an image obtained by synthesizing four images.

The original camera images processed in the server are downsized appropriately according to the number of input camera images into a single image.

When HD resolution is employed, and the input image is compressed to 640*360, which is half of 1280*720, a total of 4 camera images may be processed simultaneously.

Since a compressed image is used for deep learning, the original image is not modified.

FIG. 5C shows an example of outputting a resultant image, which requires two processes after deep learning is performed.

Since there is no boundary when four images are concatenated into a single image, deep learning is performed on the single image. It means that an object may be wrongly recognized at the four image boundaries.

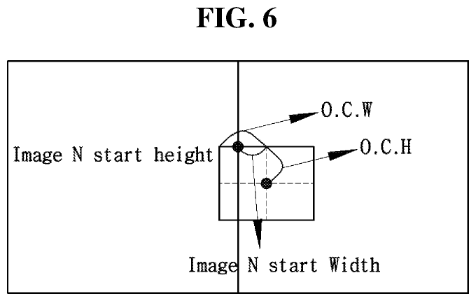

FIG. 6 illustrates a pseudo-equation in a question sentence for evaluating boundary images.

Eq. 1 shows a pseudo-equation in a question sentence for evaluating boundary images.

$$Object in a image N = \{ \begin{matrix}1 & ( O . C . W - Image N start width > 1 / 4 O . C . W ) \&\& ( O . C . H - Image N start height > 1 / 4 O . C . H ) \\ 0 & New objects Recognized at Boundaries\end{matrix} \qquad [ Eq . 1 ]$$

Eq. 1 is a pseudo-equation that checks whether an object detected in the image obtained by concatenating N images is a valid object actually present in a nearby image, where the equation corresponding to 1 indicates that the image belongs to the Nth image while 0 indicates that the corresponding detected image does not belong to the region.

In the equation corresponding to 1, O.C.W stands for Object Center Width and represents the horizontal coordinate of a detected object's center when the top-left coordinates of the object are set to 0.

Image N start width represents the horizontal distance from the boundary of an adjacent image to the center of the detected object. On the other hand, O.C.H represents the vertical coordinate of a detected object's center when the top-left coordinates of the object are set to 0, and Image N start height represents the vertical distance from the boundary of the adjacent image to the center of the detected object.

In the case of Image N start height, images concatenated in the horizontal direction unconditionally show the value of 1, and images concatenated in the vertical direction are used to check which part of an upper and a lower image contains the object.

On the other hand, in the case of Image N start width, images concatenated in the vertical direction unconditionally show the value of 1, and images concatenated in the horizontal direction are used to check which part of a left and a right image contains the object.

Any object not belonging to the case of the pseudo equation's value of 1 in Eq. 1 is classified as false (not belonging to the corresponding image).

Therefore, the present disclosure first performs the algorithm that evaluates which image contains a recognized object or whether the recognized object is regarded as a new object.

Eq. 1 is an equation that evaluates whether an object recognized in the vicinity of the image boundary is a valid object using the center point of the recognized object.

After evaluation, a correction process is performed to insert the reduced positions and recognized size for each camera image area into the original image size. After the correction, a resultant image is obtained by inserting recognized object information into the original, unmodified image.

FIG. 5D shows an example of a result obtained by applying a method for improving hardware usage in a control server using artificial intelligence image processing according to the present disclosure.

The test of FIG. 5D has been performed using two cameras.

In general, when a deep learning function is performed, a process is assigned and performed according to an input value. Given that one hardware component and two input data, if parallel processing is not employed, the execution speed is cut down to half even if the processes are executed simultaneously. Or the processes are not performed since they are already occupied.

In the case of a deep learning model used in the test of FIG. 5D according to the present disclosure, the process is designed to be performed at a maximum speed of 30 fps and not to show a significant change in the processing speed even for two input data. If a white area with a width of 10 pixels is applied between the two images when they are concatenated during the initial stage of the process, misrecognition may be further reduced.

The system and the method for improving hardware usage in a control server using artificial intelligence image processing according to the present disclosure process multiple data using one hardware component by designing an optimal task processed according to the size of input image data by including a process which receives images, compresses image resolution appropriately to be suitable for the number of input cameras, performs deep learning, and crops out the input images subsequently before executing an artificial intelligence model.

As described above, it should be understood that the present disclosure may be implemented in various other modified forms without departing from the inherent characteristics of the present disclosure.

In this respect, the specific embodiments should be considered in a descriptive point of view rather than restrictive point of view. The technical scope of the present disclosure should be judged by the appended claims rather than the descriptions given above, and all of the discrepancies which may be found within the range equivalent to the technical scope of the present disclosure should be interpreted to belong thereto.

### DETAILED DESCRIPTION OF MAIN ELEMENTS

10: Image input unit
20: Image data pre-processing unit
30: Artificial intelligence task performance unit
40: Resultant image output unit

What is claimed is:

1. A system for improving hardware usage in a control server using artificial intelligence image processing, the system comprising:
an image input unit receiving multiple images, temporarily storing input original images, and transmitting image data into one hardware component;
an image data pre-processing unit converting multiple images into images with smaller resolution to process the multiple images according to the image resolution of a single image and concatenating the converted images into a single image;
an artificial intelligence task performance unit retrieving a data learning model for an object to be recognized and performing an object recognition artificial intelligence task using the data for which pre-processing of image data has been applied; and
a resultant image output unit checking boundary coordinates along which images are concatenated according to the number of input images and calculating the center coordinates of each recognized object in the vicinity of the image boundaries, checking the distances from the center point of each object to the image boundaries and the length ratio of horizontal ends of the object and performing calculation of coordinate generation in proportion to the original image size through the detected coordinates of the object, and converting an object detection area in proportion to the original image size and outputting a resultant image by displaying the corresponding coordinates and detected area on each original image.

2. The system of claim 1, wherein the image data pre-processing unit includes an image size conversion unit converting multiple images into images with a smaller size to be processed according to the resolution of a single image and a single image generation unit concatenating the converted images at the same size into a single image.

3. The system of claim 1, wherein the resultant image output unit includes a boundary coordinate checking unit checking boundary coordinates along which images are concatenated according to the number of input images,
a center coordinate detection calculation unit calculating detection of center coordinates of each recognized object in the vicinity of image boundaries,
a length ratio checking unit checking the distances from the center point of each object to the image boundaries and the length ratio of horizontal ends of the object, and
a boundary coordinate distance comparison unit comparing a distance from the center point of an object to the image boundary with a half horizontal length of the object.

4. The system of claim 3, wherein the boundary coordinate distance comparison unit compares the distance from an object's center position to the image boundary with a half horizontal length of the object and excludes the corresponding object if the distance between the center point and the boundary coordinates is smaller than a reference value.

5. The system of claim 3, wherein the boundary coordinate distance comparison unit compares the distance from an object's center position to the image boundary with a half horizontal length of the object and limits a detected size of the corresponding object up to the image boundary if the distance between the center point and the boundary coordinates is larger than a reference value.

6. The system of claim 3, wherein the resultant image output unit further includes:
a coordinate generation calculation unit retrieving a temporarily stored original image by reflecting a comparison result of the boundary coordinate distance comparison unit and calculating generation of coordinates in proportion to the original image size through the object's detected coordinates,
an object detection area conversion unit converting an object detection area in proportion to the original image size, and
a detection area output unit outputting a resultant image by displaying the corresponding coordinates and detected area on each original image.

7. A method for improving hardware usage in a control server using artificial intelligence image processing, the method comprising:
inputting images by receiving multiple images, temporarily storing input original images, and transmitting image data into one hardware component;
pre-processing image data by converting multiple images into images with smaller resolution to process the multiple images according to the image resolution of a single image and concatenating the converted images into a single image;
performing an artificial intelligence task by retrieving a data learning model for an object to be recognized and performing an object recognition artificial intelligence task using the data for which pre-processing of image data has been applied; and
outputting a resultant image by checking boundary coordinates along which images are concatenated according to the number of input images and calculating the center coordinates of each recognized object in the vicinity of image boundaries, checking the distances from the center point of each object to the image boundaries and the length ratio of horizontal ends of the object and performing calculation of coordinate generation in proportion to the original image size through the detected coordinates of the object, and converting an object detection area in proportion to the original image size and outputting a resultant image by displaying the corresponding coordinates and detected area on each original image.

8. The method of claim 7, wherein the pre-processing image data includes converting an image size converting multiple images into images with a smaller size to be processed according to the resolution of a single image and generating a single image concatenating the converted images at the same size into a single image.

9. The method of claim 7, wherein the outputting the resultant image includes checking boundary coordinates checking boundary coordinates along which images are concatenated according to the number of input images,
calculating detection of center coordinates calculating detection of center coordinates of each recognized object in the vicinity of image boundaries,
checking a length ratio checking the distances from the center point of each object to the image boundaries and the length ratio of horizontal ends of the object, and
comparing a boundary coordinate distance comparing a distance from the center point of an object to the image boundary with a half horizontal length of the object.

10. The method of claim 9, wherein the comparing the boundary coordinate distance compares the distance from an object's center position to the image boundary with a half horizontal length of the object and excludes the corresponding object if the distance between the center point and the boundary coordinates is smaller than a reference value.

11. The method of claim 9, wherein the comparing the boundary coordinate distance compares the distance from an object's center position to the image boundary with a half horizontal length of the object and limits a detected size of the corresponding object up to the image boundary if the distance between the center point and the boundary coordinates is larger than a reference value.

12. The method of claim 9, wherein the outputting the resultant image further includes calculating generation of coordinates by retrieving a temporarily stored original image by reflecting a comparison result of the boundary coordinate distance comparison unit and calculating generation of coordinates in proportion to the original image size through the object's detected coordinates,
converting an object detection area converting an object detection area in proportion to the original image size, and
outputting a detection area outputting a resultant image by displaying the corresponding coordinates and detected area on each original image.

13. The method of claim 7, wherein the outputting the resultant image uses the following pseudo equation for checking whether the position of an object detected in an image obtained by concatenating N images corresponds to a valid object actually existing in adjacent images,
$$Object in a image N = \{ \begin{matrix}1 & ( O . C . W - Image N start width > 1 / 4 O . C . W ) \&\& ( O . C . H - Image N start height > 1 / 4 O . C . H ) \\ 0 & New objects Recognized at Boundaries\end{matrix}$$
where the equation corresponding to 1 indicates that the corresponding detected image object belongs to the N-th image, and the equation corresponding to 0 indicates that the corresponding detected image object does not belong to the area.

14. The method of claim 13, wherein, in the equation corresponding to 1, O.C.W stands for Object Center Width and represents the horizontal coordinate of a detected object's center when the top-left coordinates of the object are set to 0, and Image N start width represents the horizontal distance from the boundary of an adjacent image to the center of the detected object,
on the other hand, O.C.H stands for Object Center Height and represents the vertical coordinate of a detected object's center when the top-left coordinates of the object are set to 0, and Image N start height represents the vertical distance from the boundary of the adjacent image to the center of the detected object.

15. The method of claim 13, wherein, in the case of Image N start height, images concatenated in the horizontal direction unconditionally show the value of 1, and images concatenated in the vertical direction are used to check which part of an upper and a lower image contains an object,
on the other hand, in the case of Image N start width, images concatenated in the vertical direction unconditionally show the value of 1, images concatenated in the horizontal direction are used to check which part of a left and a right image contains the object, and
any object not belonging to the case of the pseudo equation corresponding to 1 is classified as false.
